(19) United States
(12) Patent Application Publication
(10) Pub. No.: US 2013/0315432 A1
(43) Pub. Date: Nov. 28, 2013

(54) EARPHONE UNIT WITH BOX FOR STOWING LEAD

(71) Applicant: HWANG-MIAW CHEN, Tu-Cheng (TW)

(72) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/600,242

(22) Filed: Aug. 31, 2012

(30) Foreign Application Priority Data
May 22, 2012 (CN) 201210159984.9

(51) Int. Cl. H04R 1/10

(52) U.S. Cl. 381/384

(57) ABSTRACT

An exemplary earphone unit includes an earphone, a plug, a box, and a lead. The lead includes a first section and a second section separate from the first section. The box includes a housing defining a first opening and a second opening, a disk mounted in the housing, a shaft fixed in the housing, a sleeve surrounding the shaft, and a spring connecting the shaft with the sleeve. The sleeve is rotatably disposed on the disk via two balls. The first section of the lead extends through the first opening to connect the plug with the disk. The second section is wound around the sleeve. The second section has one end fixed to the sleeve, and an opposite end extending through the second opening to connect the earphone. The spring accumulates elastic potential energy when the spring is pulled by the second section of the lead away from the sleeve.

### BACKGROUND

1. Technical Field

The disclosure generally relates to earphone units, and more particularly to an earphone unit having a box to receive a lead thereof.

2. Description of Related Art

Earphones are used widely in portable music playing devices. An earphone is generally connected to a plug through a wire. In use, the plug is inserted into a jack of a music playing device so that sound signals can be transmitted to the earphone through the wire. The wire typically has a large length for meeting different wearing requirements of the earphone. However, the long wire is difficult to manage, including when the earphone is not in use. In particular, the long wire is liable to become tangled and may even be damaged.

What is needed, therefore, is a means to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, like reference numerals designate corresponding parts throughout the views.

FIG. 1 is a schematic, side cutaway view of an earphone unit in accordance with an embodiment of the present disclosure.

FIG. 2 is essentially a top plan view of a shaft, a volute spring, a sleeve and a lead of the earphone unit of FIG. 1, wherein a circular plate of the earphone unit is omitted.

FIG. 3 is essentially a cross-sectional view of the parts of the earphone unit shown in FIG. 2, taken along line III-III thereof, also showing the circular plate, but omitting the lead.

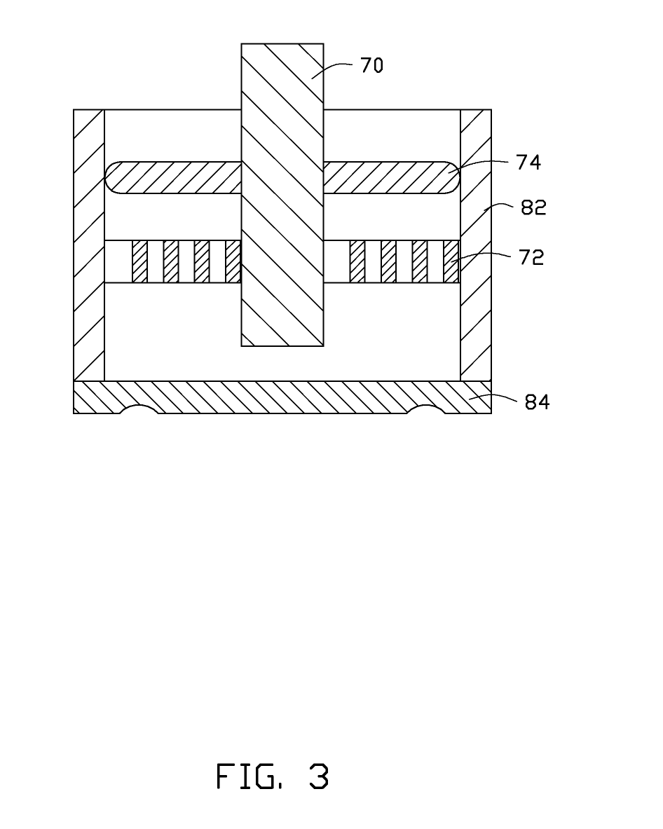

FIG. 4 is a schematic, side cutaway view of an earphone unit in accordance with another embodiment of the present disclosure.

### DETAILED DESCRIPTION

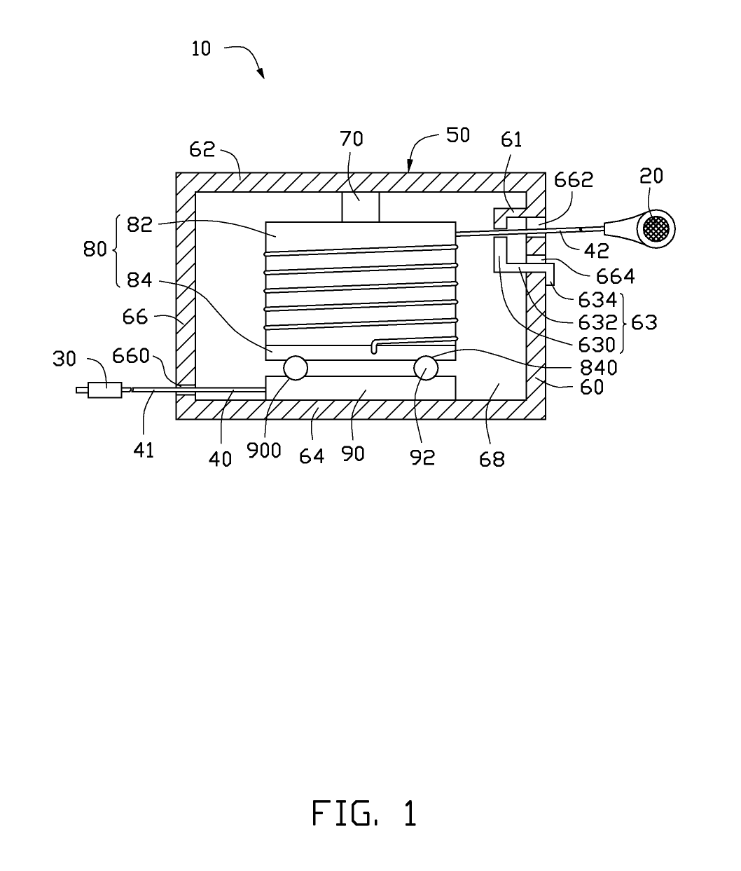

Referring to FIG. 1, an earphone unit 10 in accordance with an embodiment of the present disclosure is shown. The earphone unit 10 includes an earphone 20, a plug 30, a lead 40 connecting between the earphone 20 and the plug 30, and a box 50 receiving the lead 40 (a size of the box 50 is exaggerated relative to the earphone 20 and the plug 30).

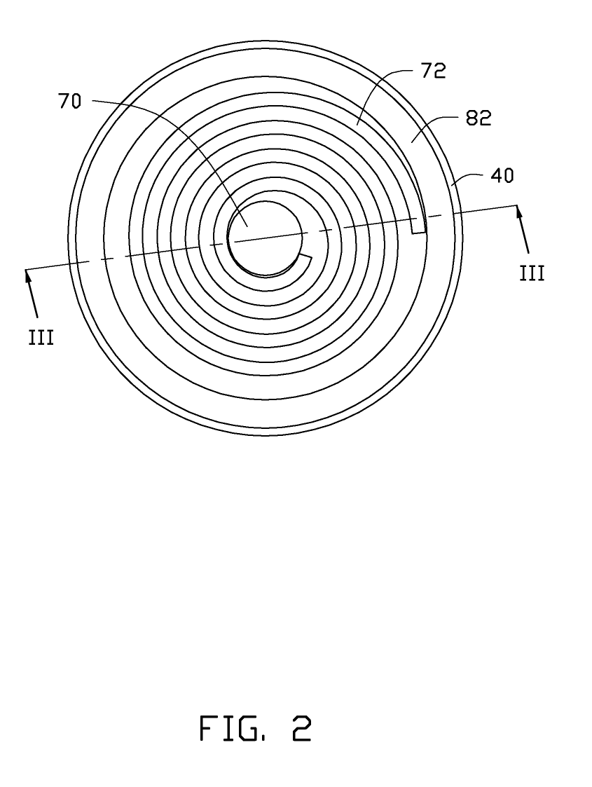

Also referring to FIG. 2, the box 50 includes a housing 60, a shaft 70 fixed to the housing 60, a sleeve 80 surrounding the shaft 70, a volute spring 72 connecting the sleeve 80 with the shaft 70, a disk 90 located below the sleeve 80, and at least two balls 92 supporting the sleeve 80 on the disk 90.

The housing 60 includes a bottom plate 64, a cylinder-shaped side plate 66 extending upwardly from a circumferential periphery of the bottom plate 64, and a top plate 62 formed on the side plate 66. The side plate 66 defines a first opening 660 and a second opening 662 in two opposite sides thereof. The first opening 660 is located adjacent to the plug 30, and the second opening 662 is located adjacent to the earphone 20. A first arm 61 extends firstly inwardly and then downwardly from an inner circumferential face of the side plate 66 at the second opening 662. The first arm 61 may be made integrally with the housing 60 as a single monolithic body of the same material. A topmost portion of the first arm 61 is located adjacent to and above the second opening 662.

A third opening 664 is defined in the side plate 66 below the second opening 662. A second arm 63 extends through the third opening 664 and is mounted in the side plate 66. The second arm 63 may be made of a flexible material such as rubber. The second arm 63 includes a first portion 632, a second portion 630 extending upwardly from an inner end of the first portion 632, and a third portion 634 extending downwardly from an opposite outer end of the first portion 632. The third portion 634 is parallel to the second portion 630, and perpendicular to the first portion 632.

The first portion 632 extends through the third opening 664, and is disposed on a bottom wall of the third opening 664 when not in use. The first portion 632 has a height (or thickness) smaller than that of the third opening 664; thus, the first portion 632 is movable within the third opening 664 along height directions of the third opening 664. Furthermore, the first portion 632 has a horizontal width (as measured along a circumference of the side plate 66) slightly larger than that of the third opening 664. Thus, the first portion 632 is interferingly movable up and down in the third opening 664. That is, the first portion 632 can be set at any height within the third opening 664 by friction generated between the first portion 632 and the side plate 66. The second portion 630 is located inside the housing 60, and a top of the second portion 630 confronts a bottom of the first arm 61. The second portion 630 can be driven by the first portion 632 to move towards or away from the bottom of the first arm 61, thereby changing a distance (gap) between the bottom of the first arm 61 and the top of the second portion 630. The third portion 634 is located outside the housing 60. The third portion 634 can be pushed by an operator downwardly or upwardly, thereby driving the first portion 632 to move accordingly.

The shaft 70 extends downwardly from a bottom face of the top plate 62. The shaft 70 has a length less than a height of the housing 60. The sleeve 80 includes a circular bottom wall 84, and a cylinder-shaped side wall 82 extending upwardly from a circumferential periphery of the bottom wall 84. The bottom wall 84 may be made of electrically conductive material such as copper, aluminum, and the like. The bottom wall 84 defines an annular groove 840 in a bottom face thereof. The side wall 82 surrounds the shaft 70. The volute spring 72 has an inner end fixed to the shaft 70, and an outer end fixed to an inner face of the side wall 82. The volute spring 72 is elastically deformed when the sleeve 80 is rotated around the shaft 70. In this embodiment, the volute spring 72 is compressed when the sleeve 80 is rotated along a clockwise direction as viewed in FIG. 2. The shaft 70 has a circular plate 74 formed at a middle thereof as measured along a height of the shaft 70. The circular plate 74 is spaced from a top face of the bottom wall 84 of the sleeve 80. The circular plate 74 has a diameter slightly smaller than an inner diameter of the side wall 82. The circular plate 74 is located above the volute spring 72. The circular plate 74 can abut against the inner face of the side wall 82 during rotation of the sleeve 80, thereby preventing the sleeve 80 from tilting. Preferably, an outer circumferential face of the circular plate 74 is smooth and curved, thereby reducing friction between the circular plate 74 and the side wall 82 when the sleeve 80 rotates about the shaft 70.

In a further embodiment (not illustrated), the circular plate 74 may define an annular recess (not shown) in the outer circumferential face thereof, and the inner face of the side wall 82 may form an annular protrusion (or bead, not shown) protruding inwardly into the recess of the circular plate 74. That is, the protrusion of the side wall 82 can be movably engaged in the recess of the circular plate 74, thereby stabilizing the rotation of the sleeve 80.

The disk 90 is fixed on a top face of the bottom plate 64. The disk 90 may be made of electrically conductive material such as copper, aluminum, and the like. The disk 90 defines an annular groove 900 in a top face thereof, corresponding to the groove 840 of the bottom wall 84. The two balls 92 are sandwiched between the disk 90 and the bottom wall 84 of the sleeve 80. Each ball 92 has a top end received in the groove 840 of the bottom wall 84, and a bottom end received in the groove 900 of the disk 90. The balls 92 are made of electrically conductive material such as copper, aluminum, and the like. The balls 92 are thus slidable along the grooves 840, 900 between the bottom wall 84 and the disk 90.

The lead 40 includes a first section 41, and a second section 42 separate from the first section 41. The first section 41 extends through the first opening 660 to electrically connect the plug 30 with the disk 90. The second section 42 is wound around an outer circumferential face of the side wall 82 of the sleeve 80. The second section 42 has one end fixed to and electrically connected with the bottom wall 84 of the sleeve 80, and an opposite end extending through the second opening 662 and connected to the earphone 20. The second section 42 also extends through the gap between the bottom of the first arm 61 and the top of the second portion 630 of the second arm 63. The second section 42 can be clasped between the first arm 61 and the second arm 63 if the gap between the bottom of the first arm 61 and the top of the second portion 630 of the second arm 63 is small enough.

In use of the earphone unit 10, the second section 42 of the lead 40 is gradually pulled out from the box 50. During pulling of the second section 42, the sleeve 80 is driven by the second section 42 to rotate along the clockwise direction (as viewed in FIG. 2). The volute spring 72 is forced by the sleeve 80 to rotate along the clockwise direction as well. The volute spring 72 is thus compressed to produce elastic potential energy, which can later be released as a restoring force. After the second section 42 is pulled to reach a desired length, the second portion 630 of the second arm 63 is pushed upwardly to fix the second section 42 between the first arm 61 and the second portion 630 of the second arm 63. Thus the earphone 20 can be used freely, with the exposed portion of the second section 42 having a required length. Sound signals are output from a signal source (not shown) to the plug 30. The plug 30 transmits the sound signals to the earphone 20 sequentially through the first section 41 of the lead 40, the disk 90, the balls 92, the bottom wall 84 of the sleeve 80, and the second section 42 of the lead 40. The earphone 20 finally converts the signals to sound.

After use of the earphone unit 10, the third portion 634 of the second arm 63 is pushed downwardly to release the second section 42 of the lead 40. The volute spring 72 decompresses and restores to its original shape, and in this process drives the sleeve 80 to rotate along an anticlockwise direction (as viewed in FIG. 2). Thus, the second section 42 of the lead 40 is automatically wound around the sleeve 80 due to the rotation of the sleeve 80.

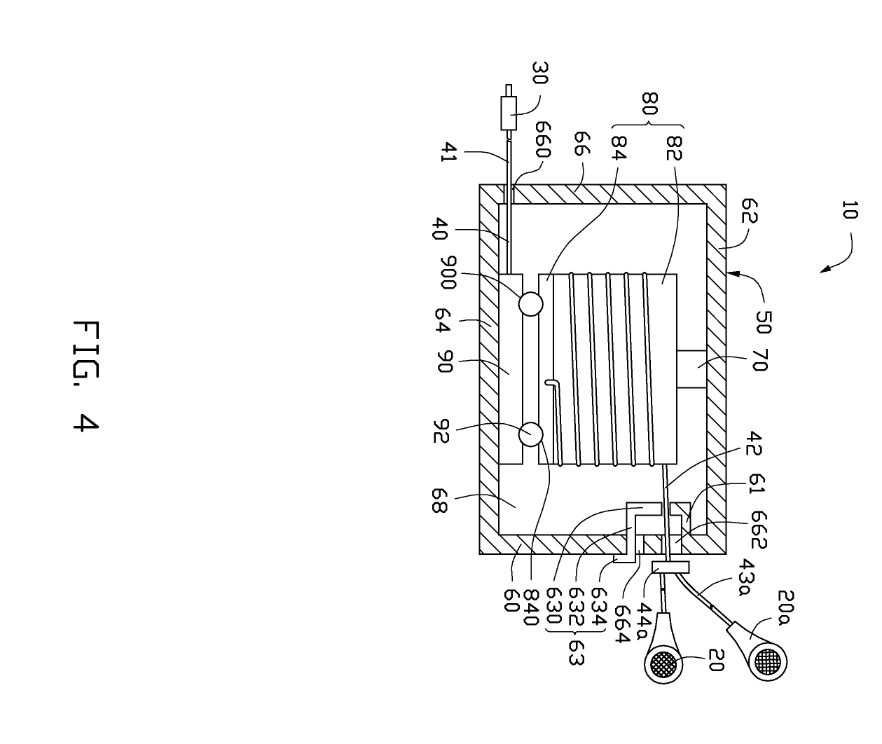

As shown in FIG. 4, in an alternative embodiment, another earphone 20a may be further connected to the lead 40 for use together with the earphone 20. The other earphone 20a is connected to the second section 42 of the lead 40 through a third section 43a of the lead 40. The third section 43a is connected to the second section 42 at a node 44a. The node 44a is located outside of the box 50. The node 44a has a width larger than a diameter of the second opening 662. Thus the node 44a can block the third section 43a from entering the box 50 through the second opening 662, preventing the third section 43a from tangling with the second section 42 inside the box 50.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An earphone unit comprising:
an earphone;
a plug;
a lead comprising a first section connected to the plug, and a second section separate from the first section; and
a box comprising:
a housing defining a first opening and a second opening;
a disk mounted in the housing;
a shaft fixed in the housing;
a sleeve surrounding the shaft and rotatably connected to the disk; and
a spring connecting the shaft with the sleeve;
wherein the first section of the lead extends through the first opening and connects the plug with the disk;
the second section of the lead is wound around the sleeve, the second section having a first end fixed to the sleeve, and an opposite second end extending through the second opening and connected to the earphone; and
the spring accumulates elastic potential energy when the sleeve is rotated by pulling the second section of the lead away from the sleeve.

2. The earphone unit of claim 1, wherein the disk is electrically conductive.

3. The earphone unit of claim 2, wherein the sleeve comprises a bottom wall and a side wall extending upwardly from a periphery of the bottom wall, the second section of the lead being wound around an outer circumferential face of the side wall.

4. The earphone unit of claim 3, wherein the bottom wall is electrically conductive.

5. The earphone unit of claim 4, wherein the first end of the second section of the lead is electrically connected to the bottom wall of the sleeve.

6. The earphone unit of claim 3, wherein the spring connects the shaft with an inner face of the side wall of the sleeve.

7. The earphone unit of claim 6, wherein the spring is a volute spring.

8. The earphone unit of claim 7, wherein the spring elastically deforms when the sleeve is rotated.

9. The earphone unit of claim 5, wherein the box further comprises two balls movably sandwiched between the bottom wall of the sleeve and the disk.

10. The earphone unit of claim 9, wherein the balls are electrically conductive.

11. The earphone unit of claim 9, wherein the bottom wall of the sleeve defines an annular groove in a bottom face thereof, the disk defines an annular groove in a top face thereof, and both the balls are movably received in the grooves.

12. The earphone unit of claim 1, wherein the housing comprises a bottom plate, a side plate extending upwardly from a periphery of the bottom plate, and a top plate formed on the side plate, and the first opening and the second opening are defined in the side plate.

13. The earphone unit of claim 12, wherein the shaft extends downwardly from a bottom face of the top plate.

14. The earphone unit of claim 12, wherein the disk is fixed on a top face of the bottom plate.

15. The earphone unit of claim 12, wherein the box further comprises a first arm formed on the side plate of the housing, and a second arm movably mounted in the side plate of the housing.

16. The earphone unit of claim 15, wherein the second section of the lead extends through a gap between the first arm and the second arm.

17. The earphone unit of claim 16, wherein the second arm is movable relative to the first arm to change a height of the gap.

18. The earphone unit of claim 15, wherein the housing defines a third opening in the side plate thereof, and the second arm extends through the third opening and is movable in vertical directions in the third opening.

19. The earphone unit of claim 1, wherein the earphone and the plug are located outside the box.

20. An earphone unit comprising:
an earphone;
a plug;
a lead comprising a first section connected to the plug, and a second section separate from the first section; and
a box, comprising:
a housing defining a first opening and a second opening;
a disk mounted in the housing;
a shaft fixed to the housing;
a sleeve surrounding the shaft and rotatably connected to the disk; and
an elastically deformable member connecting the sleeve with the shaft;
wherein the first section of the lead extends through the first opening and connects the plug with the disk;
the second section of the lead is wound around the sleeve, the second section having one end fixed to the sleeve, and an opposite end extending through the second opening and connected to the earphone;
when the second section of the lead is pulled in a direction away from the second opening to an outside of the housing, the second section of the lead drives the sleeve to rotate about the shaft along a first direction and the elastically deformable member is compressed; and
when after such pulling the second section of the lead is released, the elastically deformable member decompresses and drives the sleeve to rotate along a second direction opposite to the first direction such that the second section of the lead is automatically rewound around the sleeve.
